(19) United States
(12) Patent Application Publication
(10) Pub. No.: US 2003/0025996 A1
(43) Pub. Date: Feb. 6, 2003

(54) Autostereoscopic display system and components therefor

(76) Inventors: Robert E. Andrews, Gross Ile, MI (US); Thomas R. Donkin, Ann Arbor, MI (US); Stuart McKay, Glasgow (GB); Steven Mason, Glasgow (GB)

Correspondence Address: Gifford, Krass, Groh, Sprinkle,, Anderson & Citkowski, PC, Suite 400, 280 N. Old Woodward Ave., Birmingham, MI, 48009, US

(21) Appl. No.: 10/161,417

(22) Filed: Jun. 3, 2002

Related U.S. Application Data
(60) Provisional application No. 60/295,500, filed on Jun. 1, 2001.

(51) Int. Cl. G02B 27/22; G02B 27/24

(52) U.S. Cl. 359/472; 359/462; 359/464

(57) ABSTRACT

A “glasses-free” autostereoscopic viewing environment based on a large-diameter, concave vacuum-controlled mirror allows the user to view and interact with a “floating” hologram-like image in real time, without the use of special peripheral devices such as shutter glasses. This technology creates the unique ability to vary focal length over a wide range, yielding superior quality stereo images. Compatibility allows PCs or high-end graphics workstations to drive the system. It also easily interfaces with most haptic devices. A telepresence embodiment allows remote viewing of a live or recorded scene while giving the user the feeling of immersion at the remote site. The remote system consists of a site sensor platform containing stereo cameras and microphones. The platform's patented ability to pan, tilt, and/or roll delivers enhanced control of the captured visual and aural images of the remote site. When captured, any telecommunications system (e.g. mobile phone, Internet, or ISDN) can deliver these images to the home site.

### REFERENCE TO RELATED APPLICATION

This application claims priority from U.S. Provisional Patent Application Serial No. 60/295,500, filed Jun. 1, 2001. The entire content of this application is incorporated herein by reference.

### FIELD OF THE INVENTION

This invention relates generally to stereoscopic technology and, in particular, to an autostereoscopic system based upon a large-diameter mirror.

### BACKGROUND OF THE INVENTION

Conventional mirrors generally constructed through the use of a reflective coating on a rigid, transparent substrate, typically glass. As such, since conventional mirrors are fixed in size, it is not possible to vary certain optical characteristics directly such as focal length following manufacture. In addition, although it is technically feasible to fabricate curved mirrors, the grinding process is extremely tedious and expensive as diameter increases, particularly if optical quality is to be maintained. Large optically polished mirrors also tend to be very heavy.

Such problems led to research in lighter-weight mirrors made of other materials, including plastics. An article published in 1961 entitled “Variable Focal Length Mirrors,” Muirhead Publications, Review of Scientific Instruments, Vol. 32, pp. 210, 211, described a mirror constructed from a thin flexible carrier having a reflective surface, the carrier being peripherally clamped to a rigid hollow housing, the interior of which was connected to a vacuum pump. In this arrangement, variation of the vacuum pressure resulted in variation of the curvature of the reflective surface so that the optical characteristics of the mirror were rendered variable.

According to U.S. Pat. No. 4,046,462, a mirror of the type just described was deployed in a tracking, three-dimensional solar energy concentrator by stretching an aluminized polymeric membrane over a hoop to achieve a desired curvature through differential loading. It was observed that the loading could be varied by utilizing a plastic membrane that has a non-uniform radial distribution of thickness with uniform differential pressure or by applying a non-uniform differential pressure on a membrane having uniform thickness.

The reflector described in U.S. Pat. No. 4,288,146 comprises a hollow housing having an opening, a flexible, elastic reflective membrane, means for coupling the membrane over the opening in a gas-tight manner, evacuation means, coupled to the housing for creating a partial vacuum in the housing tending to deflect the membrane below a reference plane and into the housing, and valve means, coupled to the housing, for controlling the depth of the deflection of the membrane, the valve means comprising an aperture located in the membrane, and a body mounted adjacent the aperture and having a flow restricting surface extending into the housing a depth equal to the depth of the desired deflection of the membrane relative to the reference plane and overlying the aperture.

By varying the depth of the flow restricting surface relative to the reference plane, a very high accuracy of adjustment of the reflector's focal length is accomplished. Advantageously, the body is in the form of a threaded shaft and can simply be rotated in a threaded sleeve to vary the depth. In addition, the flow restricting surface can advantageously be a curved head coupled on the end of the shaft to provide an inexpensive valve mechanism. By forming the valve of such material and configuration and by making the reflective part of the apparatus from a flexible, elastic membrane, the overall reflector is very light, rugged and inexpensive. The adjustment of the focal length is thus very simply done by unskilled personnel.

However, the quality of the mirror produced in accordance with these approaches was sufficient only for use as a flux collector and concentrator; the mirror did not possess the quality to function in an image-forming mode. The membrane mirror described in U.S. Pat. No. 5,109,300 solved these deficiencies of the prior art by providing a variable focal length mirror assembly incorporating a rigid circular structure defining a hollow chamber with a circular aperture. A flexible elastomer having a reflective coating is disposed across the aperture with the coating outwardly facing. The elastomer is peripherally gripped and clamped by a circularly-extending clamp means located radially outwardly of the structure. The clamp means are mounted for movement axially of the structure in order to render flat that portion of the elastomer covering the aperture in the absence of any applied elastomer deformation force. Means for applying elastomer deformation forces are provided, resulting in an adjustable reflective surface exhibiting superior optical quality.

Since that time, these more precise membrane mirrors have been used stereoscopic viewing systems, which allow an observer to see three dimensions in the same way as we naturally do; that is, by allowing each eye to perceive an image with a slightly different perspective due to the natural separation of our retinas. The two images are superimposed so as to create a fully three-dimensional landscape.

Stereoscopy is over 160 years old and has been accomplished in many different ways. Over the last decade developments in computer technology have created the ability to view real time stereoscopic images. Computer-based stereoscopic viewing starts with the software generating two perspective views simultaneously, a left-eye view and a right-eye view. This is a function that has been supported by OpenGL for some time.

Traditional methods then utilize a staggered image approach that seemingly displays the two images at the same time, one right on top of the other. Known as “page flipping,” the two full-resolution images are output alternately at the speed of the monitor's vertical refresh rate. At the same time, a synchronization pulse is generated on the card and outputted via a stereo connector used to drive and infrared emitter. Cumbersome eyewear acts as a separation device, ensuring that the left eye image is only seen by the left eye, and the right eye image is only seen by the right eye.

This approach, while creating a respectable 3D image has many distinct drawbacks. First, the systems are both costly and often require a great deal of power (as a result of only using half of the projection devices light per eye). High-end systems can cost upwards of $2 million dollars. Low end systems are more cost effective yet they suffer from the same fundamental physical deficiencies as outlined below.

One of the most common complaints from people using the above systems is that the “stereo glasses” cause excessive eye strain over even short periods of use. This is not surprising as the mind is well aware that there is some physical flickering object (the lenses) right in front of the eyes, while at the same time the created image is trying to pull the mind through the lenses to an object that is perceived to be some distance away. This conflict causes both an inherent loss of depth perception over time as well as headaches and nausea.

### SUMMARY OF THE INVENTION

This invention overcomes deficiencies in the prior art by providing a “glasses-free” autostereoscopic viewing environment. The system allows the user to view and interact with a “floating” hologram-like image in real time, without the use of special peripheral devices such as shutter glasses.

Central to the system is a large-diameter, concave vacuum-controlled mirror. This technology creates the unique ability to vary focal length over a wide range, yielding superior quality stereo images. Compatibility allows PCs or high-end graphics workstations to drive the system. It also easily interfaces with most haptic devices.

A telepresence embodiment allows remote viewing of a live or recorded scene while giving the user the feeling of immersion at the remote site. The remote system consists of a site sensor platform containing stereo cameras and microphones. The platform's patented ability to pan, tilt, and/or roll delivers enhanced control of the captured visual and aural images of the remote site. When captured, any telecommunications system (e.g. mobile phone, Internet, or ISDN) can deliver these images to the home site.

### BRIEF DESCRIPTION OF THE DRAWINGS

FIG. 1 is a diagram which shows how left and right eye views are projected on the surface of a mirror via an image agglomeration device, and are thereby presented to an observer as either a ‘real’ or virtual image;

FIG. 2 is a drawing of a variable focal length mirror comprises three main parts, namely, a dish preferably of a fiberglass composite material, a clamping ring, and a flexible membrane having a reflective surface; and

FIG. 3 is a drawing which shows how a vacuum chamber sealed with an o-ring fits into matching grooves in the dish and the clamping ring.

### DETAILED DESCRIPTION OF THE INVENTION

This invention resides in a real-time, glasses-free, autostereoscopic display system, wherein a large-diameter, concave, flexible membrane mirror is used both as a viewing screen and optical element. The mirror offers considerable advantages over traditional imaging optics in terms of reduced weight and cost. The mirror is also remarkable in its ability to vary the radius of curvature to give a wide range of mirror f/Nos. (from optically flat to around f/0.5 using current membranes).

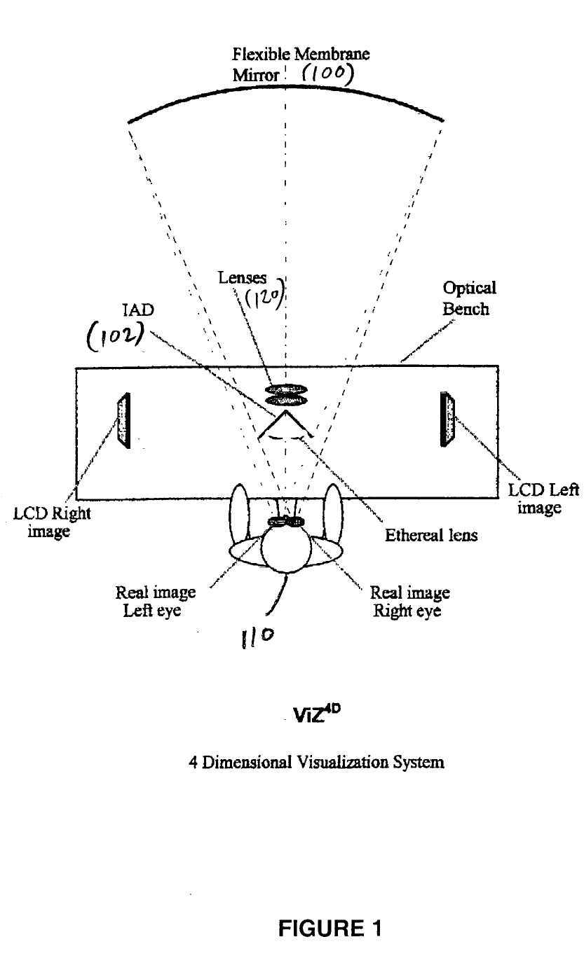

As shown in FIG. 1, left and right eye views are projected on the surface of the mirror 100, via an image agglomeration device (IAD, 102), and are thereby presented to the observer 110 as either a ‘real’ or virtual image. The view ‘pairs’ preferably originate from 2 flat panel LCD display units 112, 114 driven by a PC, or as output from 2 video cameras (not shown).

One or more lenses 120, mounted between the IAD 102 and the flexible mirror 100, allow a volumetric image to be focused. The focal lengths of the lenses and mirror, and the relative position of the display units 112, 114, determine the size and position of the volumetric image in observer space.

The image can be formed off the plane of the mirror, making both real and very large sized virtual images possible. Such a configuration minimizes light loss, giving a very bright image against the specular reflecting surface of the mirror 100. Several formats, ranging from simple stereo photographs to live stereo video feeds in a telepresence display may be viewed using this system.

Advantages of the system include:

No requirement for special headsets or viewing glasses;

Very bright image due to the optical configuration used and viewing screen's specular reflecting surface;

Large-sized images are possible (determined by mirror aperture);

Ability to accurately position the image plane in space; and

Continuous display of stereo images (non-field sequential).

The mirror 100 is preferably implemented as a large-diameter membrane mirror, similar to that described in U.S. Pat. Nos. 4,288,146 and 5,109,300 the content of both being incorporated herein by reference. Conveniently, the sources of the right and left images, whether produced from a liquid-crystal display, cathode-ray tube or other source, may be located off to the side and even out of the peripheral vision of the observer 110. Preferably, the image sources may be diametrically opposed from one another, along the same optical axis, enabling the IAD 102 to assume a 90-degree geometry. The lenses 120 may then be disposed immediately in front of the IAD 102 as shown, aligned along the optical axis of the mirror 100.

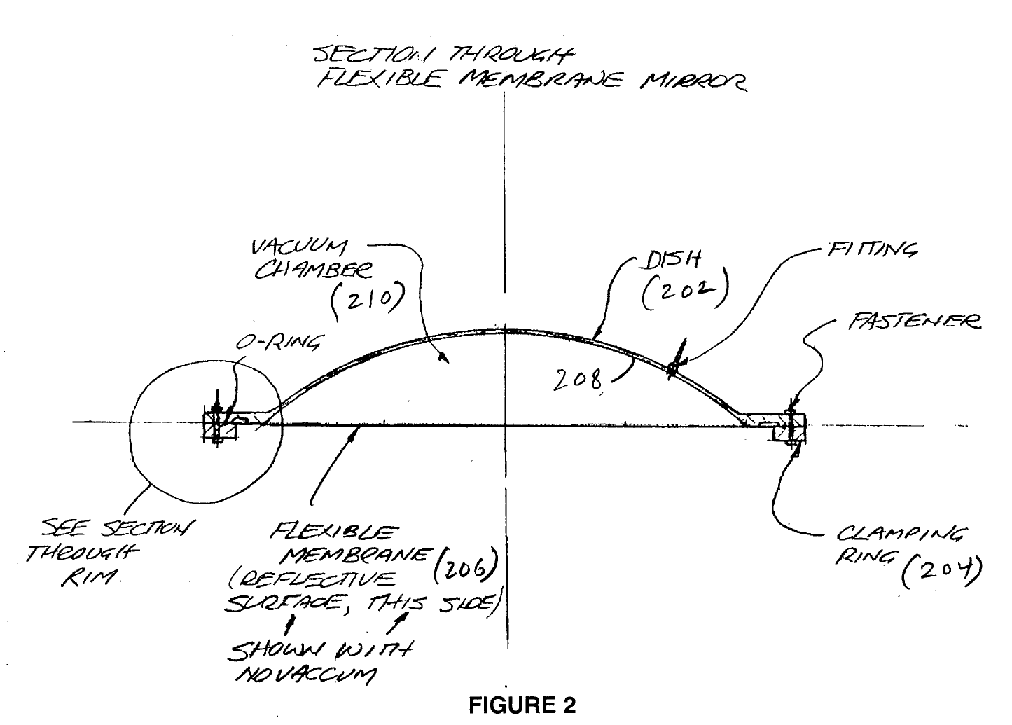

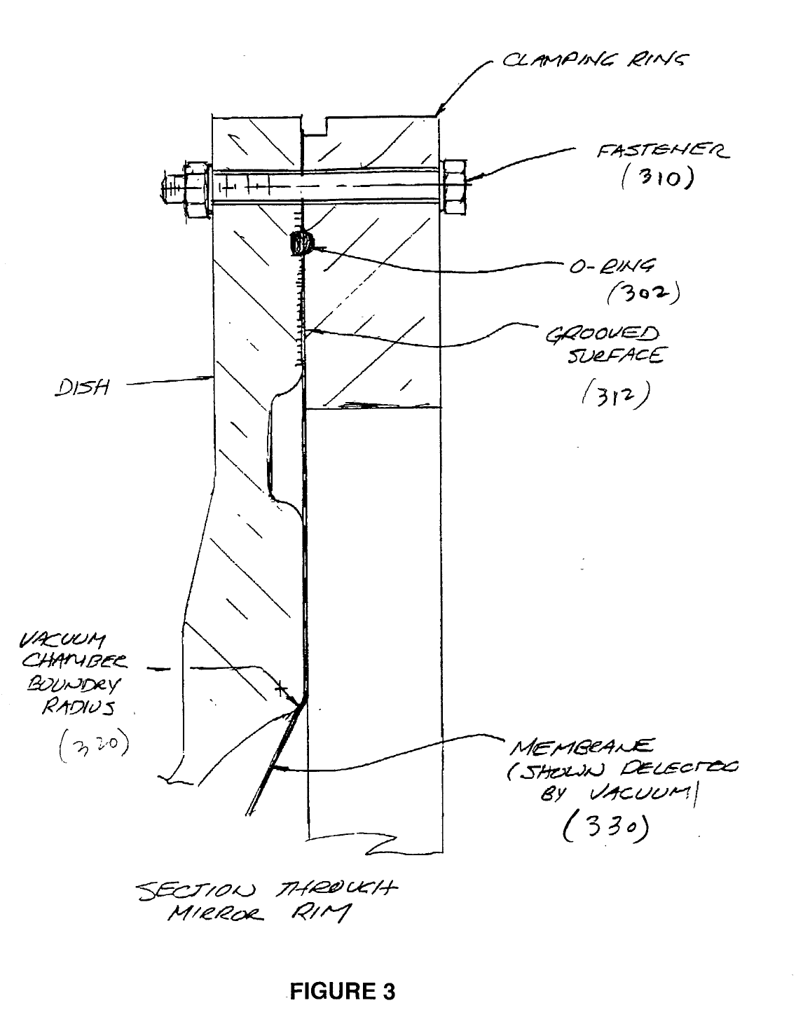

As shown in FIG. 2, the variable focal length mirror comprises three main parts: a dish 202 preferably of a fiberglass composite material; a clamping ring 204; and a flexible membrane 206 having a reflective surface 208. When the components are assembled, a vacuum chamber 210 is created behind the membrane 206. As shown in FIG. 3, the vacuum chamber is sealed with an o-ring 302, which fits into matching grooves in the dish and the clamping ring. The assembly is held together with fasteners, such as bolts 310.

In one embodiment, the dish rim is provided with a series of small, equally spaced circular grooves 312 that serve to retain the membrane when it is clamped between the dish and clamping ring.

The radius 320 that forms the circumference of the vacuum chamber is chosen to impart a suitable initial slope, called the mirror surface departure angle, to the flexible membrane. This is desirable to obtain the required optical shape and to minimize tension in the membrane 330.

Threaded holes in the back of the dish are provided with air fittings and gauges to allow for a vacuum to be generated in the chamber behind the membrane and for the control of that vacuum, enabling the membrane to attain a shape necessary to be optically useful.

The use of fiberglass composite material for the dish and clamping ring provides a mirror assembly that is relatively lightweight and easy to transport, mount, align and move in the associated mounting structure. For example, a variable focal length mirror using a flexible membrane approximately 5 feet in diameter weighs less than 200 pounds assembled. This is compared to similar mirrors of glass or metal parts, which weights approximately 1000 pounds, costs millions of dollars and is unable to produce variable focal ranges.

Telepresence system allows remote viewing of a live or recorded scene while giving the user the feeling of immersion at the remote site. The remote system consists of a site sensor platform containing stereo cameras and microphones. The platform's patented ability to pan, tilt, and/or roll delivers enhanced control of the captured visual and aural images of the remote site. When captured, any telecommunications system (e.g. mobile phone, Internet, or ISDN) can deliver these images to the home site.

1. An autostereoscopic display system, comprising:
a concave, flexible membrane mirror having a reflective surface;
a pair of displays, one each associated with left and right eye views of an image which are projected onto the reflective surface of the mirror; and
an image agglomeration device operative to present the image to an observer.

2. The autostereoscopic display system of claim 1, further including one or more lenses supported between the image agglomeration device and the mirror enabling a volumetric image to be focused to the observer.

3. The autostereoscopic display system of claim 1, wherein the image can be formed off the plane of the mirror, making possible both real and very large sized virtual images.
